(19) United States
(12) Patent Application Publication
(10) Pub. No.: US 2026/0136036 A1
(43) Pub. Date: May 14, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Semih ESENLIK, Los Angeles, CA (US); Yaojun WU, Beijing (CN); Zhaobin ZHANG, Los Angeles, CA (US); Meng WANG, Beijing (CN); Kai ZHANG, Los Angeles, CA (US); Li ZHANG, Los Angeles, CA (US)

(21) Appl. No.: 19/435,592

(22) Filed: Dec. 29, 2025

(30) Foreign Application Priority Data
Jun. 29, 2023 (WO) PCT/CN2023/103847

(51) Int. Cl. H04N 19/44; H04N 19/40; H04N 19/61; H04N 19/86

(52) U.S. Cl. CPC H04N 19/44; H04N 19/40; H04N 19/61; H04N 19/86

(57) ABSTRACT

Embodiments of the present disclosure provide a solution for visual data processing. A method for visual data processing is proposed. The method comprises: performing, with a neural network (NN)-based model, a conversion between visual data and a bitstream of the visual data based on a plurality of decoding profiles for decoding the bitstream, the plurality of decoding profiles being different from each other.

### CROSS REFERENCE TO RELATED APPLICATIONS

This application is a continuation of International Application No. PCT/CN2024/102649, filed on Jun. 28, 2024, which claims the benefit of International Application No. PCT/CN2023/103847, filed on Jun. 29, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding efficiency of neural network-based image/video coding is generally expected to be further improved.

### SUMMARY

Embodiments of the present disclosure provide a solution for visual data processing.

In a first aspect, a method for visual data processing is proposed. The method comprises: performing, with a neural network (NN)-based model, a conversion between visual data and a bitstream of the visual data based on a plurality of decoding profiles for decoding the bitstream, the plurality of decoding profiles being different from each other.

Based on the method in accordance with the first aspect of the present disclosure, a bitstream may be decoded based on a plurality of different decoding profiles. Compared with the conventional solution where the bitstream supports only one specific decoding profile, the proposed method can advantageously enable a selection of the decoding profile for decoding the bitstream, e.g., based on capability of a decoder and/or the application requirement. Thereby, the coding flexibility can be improved and thus the coding efficiency can be enhanced.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: performing, with a neural network (NN)-based model, a conversion between the visual data and the bitstream based on a plurality of decoding profiles for decoding the bitstream, the plurality of decoding profiles being different from each other.

In a fifth aspect, a method for storing a bitstream of visual data is proposed. The method comprises: generating, with a neural network (NN)-based model, the bitstream based on a plurality of decoding profiles for decoding the bitstream, the plurality of decoding profiles being different from each other; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure:

FIG. 1B is a schematic diagram illustrating an example transform coding scheme;

FIG. 2 illustrates example latent representations of an image;

FIG. 3 is a schematic diagram illustrating an example autoencoder implementing a hyperprior model;

FIG. 4 is a schematic diagram illustrating an example combined model configured to jointly optimize a context model along with a hyperprior and the autoencoder;

FIG. 5 illustrates an example encoding process;

FIG. 6 illustrates an example decoding process;

FIG. 7 illustrates an example decoding process according to the present disclosure;

FIG. 8 illustrates an example learning-based image codec architecture;

FIG. 9 illustrates an example synthesis transform for learning based image coding;

FIG. 10 illustrates an example LeakyReLU activation function;

FIG. 11 illustrates an example ReLU activation function;

FIG. 12 illustrates an example of the pixel shuffle and unshuffle operations;

FIG. 13 illustrates an example of a transposed convolution with a 2×2 kernel;

FIG. 14 illustrates an example Enhancement Filtering Extensions (EFE) filtering process;

FIG. 15 illustrates an example image and/or video compression scheme;

FIG. 16 illustrates an example implementation of a video compression scheme for performing the disclosed examples;

FIG. 17 illustrates an example implementation of a video compression scheme for performing the disclosed examples;

FIG. 18 illustrates an example implementation of a video compression scheme for performing the disclosed examples;

FIG. 19 illustrates an example implementation of a video compression scheme for performing the disclosed examples;

FIG. 20 illustrates an example implementation of a video compression scheme for performing the disclosed examples;

FIG. 21 illustrates an example implementation of a video compression scheme for performing the disclosed examples;

FIG. 22 illustrates a flowchart of a method for visual data processing in accordance with embodiments of the present disclosure; and

FIG. 23 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

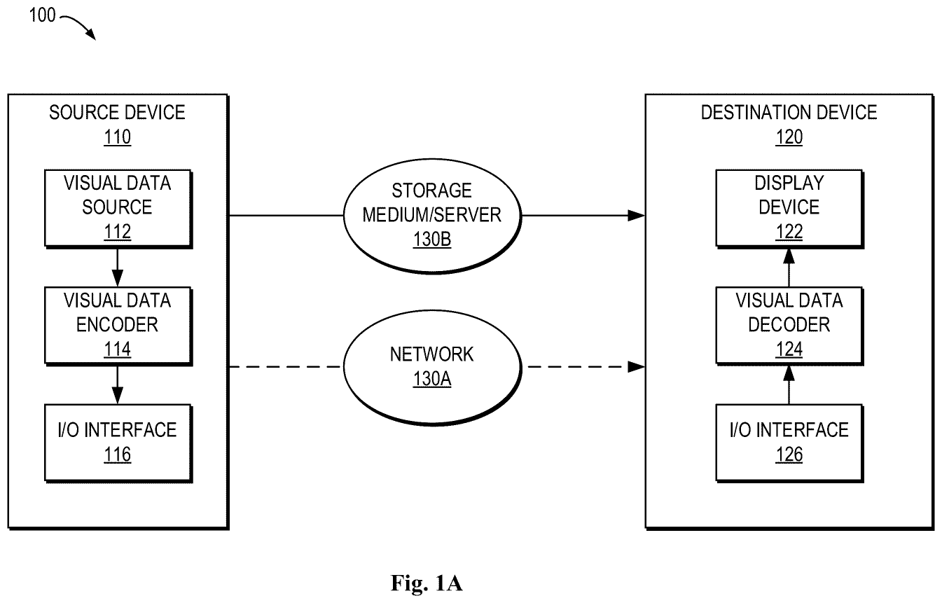

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. 1. Initial Discussion

This patent document is related to a neural image and video compression approach comprising multiple operating points. A single bitstream is used by the decoder to obtain multiple reconstructions. In one specific example, the compression method is a neural network-based compression method. In one specific example, quality of the multiple reconstructions are indicated in the bitstream.

### 2. 2. Further Discussion

Deep learning is developing in a variety of areas, such as in computer vision and image processing. Inspired by the successful application of deep learning technology to computer vision areas, neural image/video compression technologies are being studied for application to image/video compression techniques. The neural network is designed based on interdisciplinary research of neuroscience and mathematics. The neural network has shown strong capabilities in the context of non-linear transform and classification. An example neural network-based image compression algorithm achieves comparable R-D performance with Versatile Video Coding (VVC), which is a video coding standard developed by the Joint Video Experts Team (JVET) with experts from motion picture experts group (MPEG) and Video coding experts group (VCEG). Neural network-based video compression is an actively developing research area resulting in continuous improvement of the performance of neural image compression. However, neural network-based video coding is still a largely undeveloped discipline due to the inherent difficulty of the problems addressed by neural networks.

### 3. 2.1 Image/Video Compression

Image/video compression usually refers to a computing technology that compresses video images into binary code to facilitate storage and transmission. The binary codes may or may not support losslessly reconstructing the original image/video. Coding without data loss is known as lossless compression and coding while allowing for targeted loss of data in known as lossy compression, respectively. Most coding systems employ lossy compression since lossless reconstruction is not necessary in most scenarios. Usually the performance of image/video compression algorithms is evaluated based on a resulting compression ratio and reconstruction quality. Compression ratio is directly related to the number of binary codes resulting from compression, with fewer binary codes resulting in better compression. Reconstruction quality is measured by comparing the reconstructed image/video with the original image/video, with greater similarity resulting in better reconstruction quality.

Image/video compression techniques can be divided into video coding methods and neural-network-based video compression methods. Video coding schemes adopt transform-based solutions, in which statistical dependency in latent variables, such as discrete cosine transform (DCT) and wavelet coefficients, is employed to carefully hand-engineer entropy codes to model the dependencies in the quantized regime. Neural network-based video compression can be grouped into neural network-based coding tools and end-to-end neural network-based video compression. The former is embedded into existing video codecs as coding tools and only serves as part of the framework, while the latter is a separate framework developed based on neural networks without depending on video codecs.

A series of video coding standards have been developed to accommodate the increasing demands of visual content transmission. The international organization for standardization (ISO)/International Electrotechnical Commission (IEC) has two expert groups, namely Joint Photographic Experts Group (JPEG) and Moving Picture Experts Group (MPEG). International Telecommunication Union (ITU) telecommunication standardization sector (ITU-T) also has a Video Coding Experts Group (VCEG), which is for standardization of image/video coding technology. The influential video coding standards published by these organizations include Joint Photographic Experts Group (JPEG), JPEG 2000, H.262, H.264/advanced video coding (AVC) and H.265/High Efficiency Video Coding (HEVC). The Joint Video Experts Team (JVET), formed by MPEG and VCEG, developed the Versatile Video Coding (VVC) standard. An average of 50% bitrate reduction is reported by VVC under the same visual quality compared with HEVC.

Neural network-based image/video compression/coding is also under development. Example neural network coding network architectures are relatively shallow, and the performance of such networks is not satisfactory. Neural network-based methods benefit from the abundance of data and the support of powerful computing resources, and are therefore better exploited in a variety of applications. Neural network-based image/video compression has shown promising improvements and is confirmed to be feasible. Nevertheless, this technology is far from mature and a lot of challenges should be addressed.

### 4. 2.2 Neural Networks

Neural networks, also known as artificial neural networks (ANN), are computational models used in machine learning technology. Neural networks are usually composed of multiple processing layers, and each layer is composed of multiple simple but non-linear basic computational units. One benefit of such deep networks is a capacity for processing data with multiple levels of abstraction and converting data into different kinds of representations. Representations created by neural networks are not manually designed. Instead, the deep network including the processing layers is learned from massive data using a general machine learning procedure. Deep learning eliminates the necessity of handcrafted representations. Thus, deep learning is regarded useful especially for processing natively unstructured data, such as acoustic and visual signals. The processing of such data has been a longstanding difficulty in the artificial intelligence field.

### 5. 2.3 Neural Networks For Image Compression

Neural networks for image compression can be classified in two categories, including pixel probability models and auto-encoder models. Pixel probability models employ a predictive coding strategy. Auto-encoder models employ a transform-based solution. Sometimes, these two methods are combined together.

### 6. 2.3.1 Pixel Probability Modeling

According to Shannon's information theory, the optimal method for lossless coding can reach the minimal coding rate, which is denoted as −log₂ p(x) where p(x) is the probability of symbol x. Arithmetic coding is a lossless coding method that is believed to be among the optimal methods. Given a probability distribution p(x), arithmetic coding causes the coding rate to be as close as possible to a theoretical limit −log₂ p(x) without considering the rounding error. Therefore, the remaining problem is to determine the probability, which is very challenging for natural image/video due to the curse of dimensionality. The curse of dimensionality refers to the problem that increasing dimensions causes data sets to become sparse, and hence rapidly increasing amounts of data is needed to effectively analyze and organize data as the number of dimensions increases.

Following the predictive coding strategy, one way to model p(x) is to predict pixel probabilities one by one in a raster scan order based on previous observations, where x is an image, can be expressed as follows:

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, estimation of the conditional probability can be difficult. Thereby, a simplified method is to limit the range of the context of the current pixel as follows:

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the red (R), green (G), and blue (B) (RGB) color component, the R sample is dependent on previously coded pixels (including R, G, and/or B samples), the current G sample may be coded according to previously coded pixels and the current R sample. Further, when coding the current B sample, the previously coded pixels and the current R and G samples may also be taken into consideration.

Neural networks may be designed for computer vision tasks, and may also be effective in regression and classification problems. Therefore, neural networks may be used to estimate the probability of p(xᵢ) given a context x₁, x₂, . . . , xᵢ₋₁.

Most of the methods directly model the probability distribution in the pixel domain. Some designs also model the probability distribution as conditional based upon explicit or latent representations. Such a model can be expressed as:

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h) indicates the modeling is split into an unconditional model and a conditional model. The additional condition can be image label information or high-level representations.

### 7. 2.3.2 Auto-Encoder

An Auto-encoder is now described. The auto-encoder is trained for dimensionality reduction and include an encoding component and a decoding component. The encoding component converts the high-dimension input signal to low-dimension representations. The low-dimension representations may have reduced spatial size, but a greater number of channels. The decoding component recovers the high-dimension input from the low-dimension representation. The auto-encoder enables automated learning of representations and eliminates the need of hand-crafted features, which is also believed to be one of the most important advantages of neural networks.

FIG. 1B is a schematic diagram illustrating an example transform coding scheme. The original image x is transformed by the analysis network gₐ to achieve the latent representation y. The latent representation y is quantized (q) and compressed into bits. The number of bits R is used to measure the coding rate. The quantized latent representation ŷ is then inversely transformed by a synthesis network gₛ to obtain the reconstructed image \hat{x}. The distortion (D) is calculated in a perceptual space by transforming x and \hat{x} with the function gₚ, resulting in z and \hat{z}, which are compared to obtain D.

An auto-encoder network can be applied to lossy image compression. The learned latent representation can be encoded from the well-trained neural networks. However, adapting the auto-encoder to image compression is not trivial since the original auto-encoder is not optimized for compression, and is thereby not efficient for direct use as a trained auto-encoder. In addition, other major challenges exist. First, the low-dimension representation should be quantized before being encoded. However, the quantization is not differentiable, which is required in backpropagation while training the neural networks. Second, the objective under a compression scenario is different since both the distortion and the rate need to be take into consideration. Estimating the rate is challenging. Third, a practical image coding scheme should support variable rate, scalability, encoding/decoding speed, and interoperability. In response to these challenges, various schemes are under development.

An example auto-encoder for image compression using the example transform coding scheme can be regarded as a transform coding strategy. The original image x is transformed with the analysis network y=gₐ(x), where y is the latent representation to be quantized and coded. The synthesis network inversely transforms the quantized latent representation ŷ back to obtain the reconstructed image \hat{x}=gₛ (y). The framework is trained with the rate-distortion loss function, [symbol] =D+λR, where D is the distortion between x and \hat{x}, R is the rate calculated or estimated from the quantized representation ŷ, and λ is the Lagrange multiplier. D can be calculated in either pixel domain or perceptual domain. Most example systems follow this prototype and the differences between such systems might only be the network structure or loss function.

### 8. 2.3.3 Hyper Prior Model

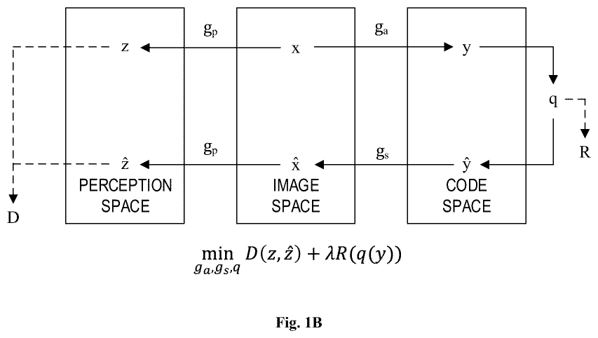

FIG. 2 illustrates example latent representations of an image. FIG. 2 includes an image 201 from the Kodak dataset, visualization of the latent 202 representation y of the image 201, a standard deviations σ 203 of the latent 202, and latents y 204 after a hyper prior network is introduced. A hyper prior network includes a hyper encoder and decoder. In the transform coding approach to image compression, as shown in FIG. 1B, the encoder subnetwork transforms the image vector x using a parametric analysis transform gₐ(x, Ø_{g}) into a latent representation y, which is then quantized to form ŷ. Because ŷ is discrete-valued, ŷ can be losslessly compressed using entropy coding techniques such as arithmetic coding and transmitted as a sequence of bits.

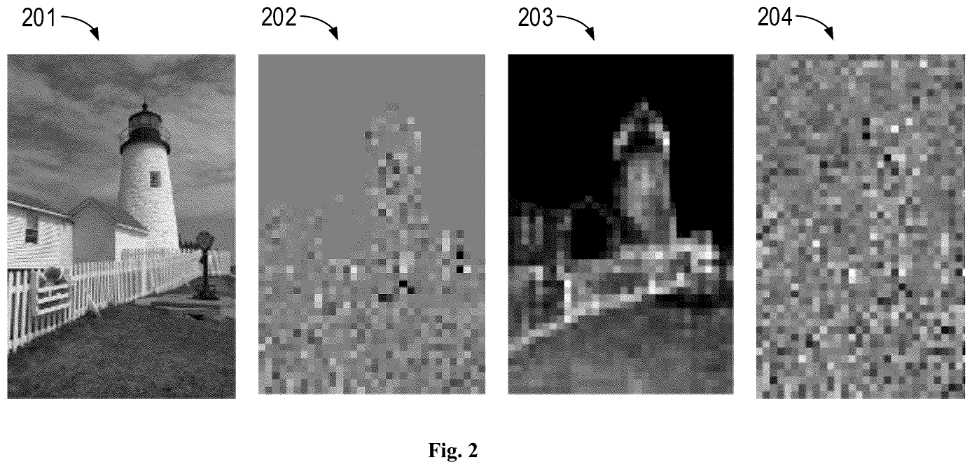

As evident from the latent 202 and the standard deviations σ 203 of FIG. 2, there are significant spatial dependencies among the elements of ŷ. Notably, their scales (standard deviations σ 203) appear to be coupled spatially. An additional set of random variables \hat{z} may be introduced to capture the spatial dependencies and to further reduce the redundancies. In this case the image compression network is depicted in FIG. 3.

FIG. 3 is a schematic diagram illustrating an example network architecture of an autoencoder implementing a hyperprior model. The upper side shows an image autoencoder network, and the lower side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model includes two subnetworks, hyper encoder (denoted with hₐ) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with y.

In FIG. 3, the upper side of the models is the encoder gₐ and decoder gₛ as discussed above. The lower side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses σ to compress and transmit the quantized image representation ŷ. The decoder first recovers \hat{z} from the compressed signal. The decoder then uses hₛ to obtain σ, which provides the decoder with the correct probability estimates to successfully recover ŷ as well. The decoder then feeds ŷ into gₛ to obtain the reconstructed image.

When the hyper encoder and hyper decoder are added to the image compression network, the spatial redundancies of the quantized latent ŷ are reduced. The latents y 204 in FIG. 2 correspond to the quantized latent when the hyper encoder/decoder are used. Compared to the standard deviations σ 203, the spatial redundancies are significantly reduced as the samples of the quantized latent are less correlated.

### 9. 2.3.4 Context Model

Although the hyper prior model improves the modelling of the probability distribution of the quantized latent ŷ, additional improvement can be obtained by utilizing an autoregressive model that predicts quantized latents from their causal context, which may be known as a context model.

The term auto-regressive indicates that the output of a process is later used as an input to the process. For example, the context model subnetwork generates one sample of a latent, which is later used as input to obtain the next sample.

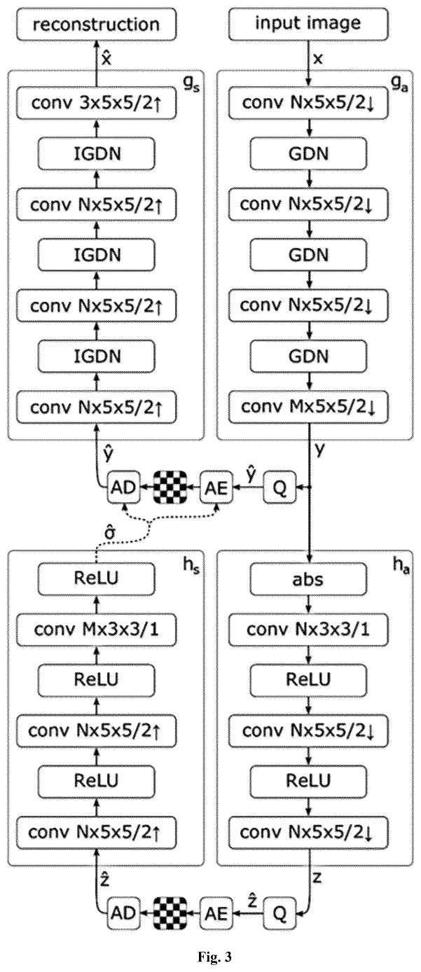

FIG. 4 is a schematic diagram illustrating an example combined model configured to jointly optimize a context model along with a hyperprior and the autoencoder. The following Table 1 illustrates meaning of different symbols.

TABLE 1
Illustration of symbols

| Component | Symbol |
|---|---|
| Input Image | x |
| Encoder | f(x; θₑ) |
| Latents | y |
| Latents (quantized) | ŷ |
| Decoder | g(ŷ; θ_{d}) |
| Hyper Encoder | fₕ (y; θₕₑ) |
| Hyper-latents | z |
| Hyper-latents (quant.) | \hat{z} |
| Hyper Decoder | gₕ (\hat{z}; θ_{hd}) |
| Context Model | g_{cm} (y_{<i}; θ_{cm}) |
| Entropy Parameters | gₑₚ (•; θₑₚ) |
| Reconstruction | \hat{x} |

The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g., a decoder) to recover an image from a compressed bitstream.

An example system utilizes a joint architecture where both a hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 4, the outputs of the context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

In an example, the latent samples are modeled as gaussian distribution or gaussian mixture models (not limited to). In the example according to FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

10. 2.3.5 Gained variational autoencoders (G-VAE)

In an example, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0, 1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c*n}, which includes n inverse gain vectors, i.e., M′={δₛ₍₀₎, δₛ₍₁₎, . . . , δ_{s(c-1)}}, δₛ₍ᵢ₎∈R. The inverse gain process is expressed as:

$${y}_{s}^{′} = \hat{y} ⊙ {m}_{s}^{′}$$

where ŷ is the decoded quantized latent representation and y′ₛ is the inversely gained quantized latent representation, which will be fed into the synthesis network.

To achieve continuous variable rate adjustment, interpolation is used between vectors. Given two pairs of gain vectors {mₜ, m′ₜ} and {mᵣ, m′ᵣ}, the interpolated gain vector can be obtained via the following equations:

$${m}_{ν} = [ {( {m}_{r} )}^{l} \cdot {( {m}_{t} )}^{1 - l} ]$$

$${m}_{ν}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 11. 2.3.6 the Encoding Process Using Joint Auto-Regressive Hyper Prior Model

The design in FIG. 4. corresponds an example combined compression method. In this section and the next, the encoding and decoding processes are described separately.

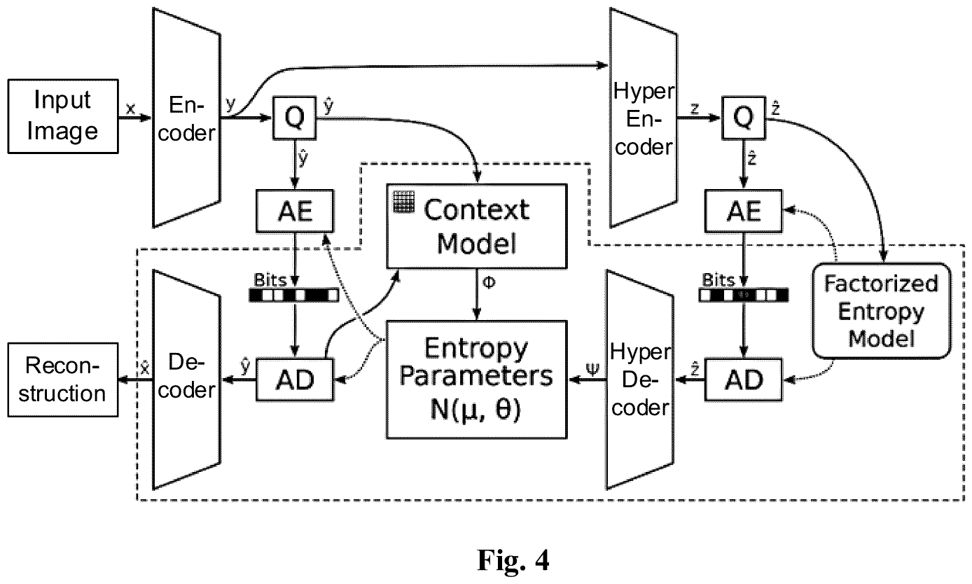

FIG. 5 illustrates an example encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples \vec{y}[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent y into bitstream (bits1).

Finally, the first and the second bitstream are transmitted to the decoder as result of the encoding process. It is noted that the other names can be used for the modules described above.

In the above description, all of the elements in FIG. 5 are collectively called an encoder. The analysis transform that converts the input image into latent representation is also called an encoder (or auto-encoder).

### 12. 2.3.7 the Decoding Process Using Joint Auto-Regressive Hyper Prior Model

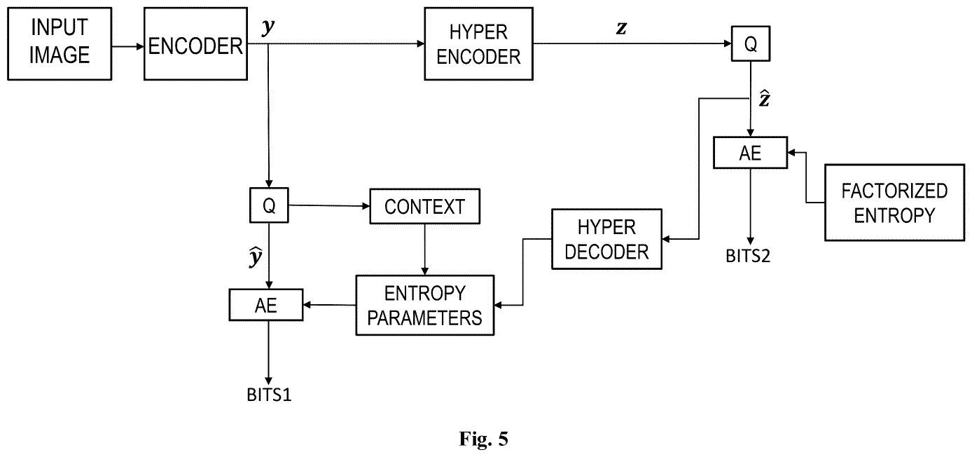

FIG. 6 illustrates an example decoding process. FIG. 6 depicts a decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g., the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization. Finally, the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 13. 2.4 Neural Networks for Video Compression

Similar to video coding technologies, neural image compression serves as the foundation of intra compression in neural network-based video compression. Thus, development of neural network-based video compression technology is behind development of neural network-based image compression because neural network-based video compression technology is of greater complexity and hence needs far more effort to solve the corresponding challenges. Compared with image compression, video compression needs efficient methods to remove inter-picture redundancy. Inter-picture prediction is then a major step in these example systems. Motion estimation and compensation is widely adopted in video codecs, but is not generally implemented by trained neural networks.

Neural network-based video compression can be divided into two categories according to the targeted scenarios: random access and the low-latency. In random access case, the system allows decoding to be started from any point of the sequence, typically divides the entire sequence into multiple individual segments, and allows each segment to be decoded independently. In a low-latency case, the system aims to reduce decoding time, and thereby temporally previous frames can be used as reference frames to decode subsequent frames.

### 14. 2.5 Preliminaries

Almost all the natural image and/or video is in digital format. A grayscale digital image can be represented by x∈ [symbol] ^{m×n}, where D is the set of values of a pixel, m is the image height, and n is the image width. For example, [symbol] ={0, 1, 2, . . . , 255} is an example setting, and in this case | [symbol] |=256=2⁸. Thus, the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green, and Blue information. Similar to the 8-bit grayscale image, an uncompressed 8-bit RGB image has 24 bpp. Digital images/videos can be represented in different color spaces. The neural network-based video compression schemes are mostly developed in RGB color space while the video codecs typically use a YUV color space to represent the video sequences. In YUV color space, an image is decomposed into three channels, namely luma (Y), blue difference chroma (Cb) and red difference chroma (Cr). Y is the luminance component and Cb and Cr are the chroma components. The compression benefit to YUV occur because Cb and Cr are typically down sampled to achieve pre-compression since human vision system is less sensitive to chroma components.

A color video sequence is composed of multiple color images, also called frames, to record scenes at different timestamps. For example, in the RGB color space, a color video can be denoted by X={x₀, x₁, . . . , xₜ, . . . , x_{T-1}} where T is the number of frames in a video sequence and x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps). This results in about 2.32 gigabits per second (Gbps), which uses a lot storage and should be compressed before transmission over the internet.

Usually the lossless methods can achieve a compression ratio of about 1.5 to 3 for natural images, which is clearly below streaming requirements. Therefore, lossy compression is employed to achieve a better compression ratio, but at the cost of incurred distortion. The distortion can be measured by calculating the average squared difference between the original image and the reconstructed image, for example based on MSE. For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$P S N R = 10 \times {log}_{10} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).
To compare different lossless compression schemes, the compression ratio given the resulting rate, or vice versa, can be compared. However, to compare different lossy compression methods, the comparison has to take into account both the rate and reconstructed quality. For example, this can be accomplished by calculating the relative rates at several different quality levels and then averaging the rates. The average relative rate is known as Bjontegaard's delta-rate (BD-rate). There are other aspects to evaluate image and/or video coding schemes, including encoding/decoding complexity, scalability, robustness, and so on.

### 2.6 Separate Processing of Luma and Chroma Components of an Image

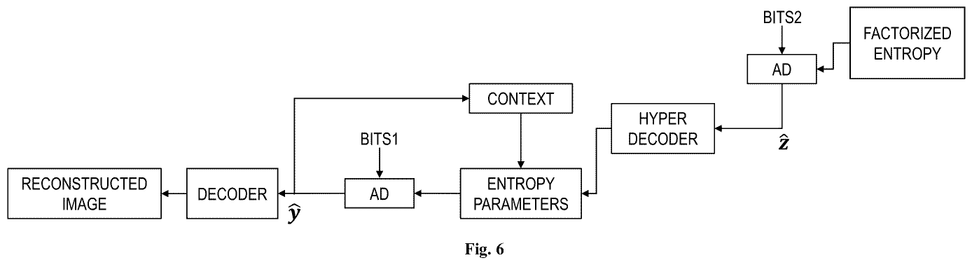

FIG. 7 illustrates an example decoding process according to the present disclosure.

According to one implementation, the luma and chroma components of an image can be decoded using separate subnetworks. In FIG. 7, the luma component of the image is processed by the subnetwoks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.

A benefit of this separate processing is that the computational complexity of the processing of an image is reduced by application of separate processing. Typically, in neural network-based image and video decoding, the computational complexity is proportional to the square of the number of feature maps. For example, if the number of total feature maps is 192, computational complexity will be proportional to 192×192. On the other hand, if the feature maps are divided into 128 for luma and 64 for chroma (in the case of separate processing), the computational complexity is proportional to 128×128+64×64, which corresponds to a reduction in complexity by 45%. Typically, the separate processing of luma and chroma components of an image does not result in a prohibitive reduction in performance, as the correlation between the luma and chroma components are typically very small.

The processing (Decoding process) in FIG. 7 can be explained below:
1. Firstly, the factorized entropy model is used to decode the quantized latents for luma and chroma, i.e., 2 and \hat{z}ᵤᵥ in FIG. 7.
2. The probability parameters (e.g., variance) generated by the second network are used to generate a quantized residual latent by performing the arithmetic decoding process.
3. The quantized residual latent is inversely gained with the inverse gain unit (iGain) as shown in orange color in FIG. 7. The outputs of the inverse gain units are denoted as ŵ and ŵᵤᵥ for luma and chroma components, respectively.
4. For the luma component, the following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
5. After all the samples of ŷ are obtained, a synthesis transform can be applied to obtain the reconstructed image.
6. For chroma component, steps 4 and 5 are the same but with a separate set of networks.
7. The decoded luma component is used as additional information to obtain the chroma component. Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed.

The module named ICCI is a neural-network based postprocessing module. The examples are not limited to the UCCI subnetwork. Any other neural network based postprocessing module might also be used.

An exemplary implementation of the disclosure is depicted in FIG. 7 (the decoding process). The framework comprises two branches for luma and chroma components respectively. In each of the branches, the first subnetwork comprises the context, prediction and optionally the hyper decoder modules. The second network comprises the hyper scale decoder module. The quantized hyper latent are \hat{z} and \hat{z}ᵤᵥ. The arithmetic decoding process generates the quantized residual latents, which are further fed into the iGain units to obtain the gained quantized residual latents ŵ and ŵᵤᵥ.

After the residual latent is obtained, a recursive prediction operation is performed to obtain the latent ŷ and ŷᵤᵥ. The following steps describe how to obtain the samples of latent ŷ[:, i, j], and the chroma component is processed in the same way but with different networks.
1. An autoregressive context module is used to generate first input of a prediction module using the samples ŷ[:, m, n] where the (m, n) pair are the indices of the samples of the latent that are already obtained.
2. Optionally the second input of the prediction module is obtained by using a hyper decoder and a quantized hyper latent \hat{z}₁.
3. Using the first input and the second input, the prediction module generates the mean value mean [:, i, j].
4. The mean value mean [:, i, j] and the quantized residual latent ŵ[:, i, j] are added together to obtain the latent ŷ[:, i, j].
5. The steps 1-4 are repeated for the next sample.

Whether to and/or how to apply at least one method disclosed in the document may be signaled from the encoder to the decoder, e.g., in the bitstream.

Whether to and/or how to apply at least one method disclosed in the document may be determined by the decoder based on coding information, such as dimensions, color format, etc.

Further, the modules named MS1, MS2 or MS3+O (in FIG. 7), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in FIG. 7 might be an entropy decoding module. It might be a range decoder or an arithmetic decoder or the like.

The examples described herein is not limited to the specific combination of the units exemplified in FIG. 7. Some of the modules might be missing and some of the modules might be displaced in processing order. In addition, additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+O might be removed. The core of the disclosure is not affected by the removing of one or more of the said scaling and adding modules.

In FIG. 7, other operations that are performed during the processing of the luma and chroma components are also indicated using the star symbol. These processes are denoted as MS1, MS2, MS3+O. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.

Another operation might be tiling operation, wherein samples are first tiled (grouped) into overlapping or non-overlapping regions, wherein each region is processed independently. For example, the samples corresponding to the luma component might be divided into tiles with a tile height of 20 samples, whereas the chroma components might be divided into tiles with a tile height of 10 samples for processing.

Another operation might be application of wavefront parallel processing. In wavefront parallel processing, a number of samples might be processed in parallel, and the amount of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 2.7 Colors Separation and Conditional Coding

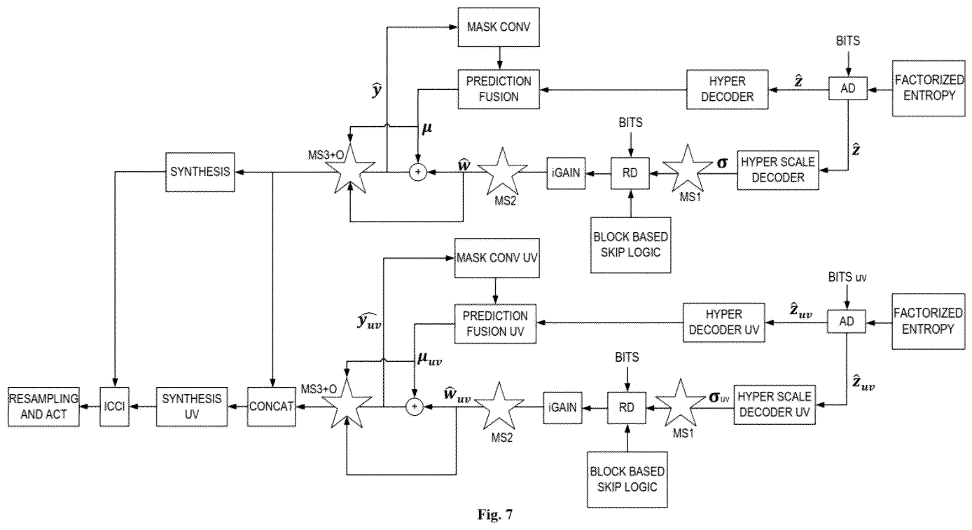

FIG. 8 illustrates an example learning-based image codec architecture.

In one example the primary and secondary color components of an image are coded separately, using networks with similar architecture, but different number of channels as shown in FIG. 8. All boxes with same names are sub-networks with the similar architecture, only input-output tensor size and number of channels are different. Number of channels for primary component is Cₚ=128, for secondary components is Cₛ=64. The vertical arrows (with arrowhead pointing downwards) indicate data flow related to secondary color components coding. Vertical arrows show data exchange between primary and secondary components pipelines.

The input signal to be encoded is notated as x, latent space tensor in bottleneck of variational auto-encoder is y. Subscript “Y” indicates primary component, subscript “UV” is used for concatenated secondary components, there are chroma components.

First the input image that has RGB color format is converted to primary (Y) and secondary components (UV). The primary component x_{Y} is coded independently from secondary components x_{UV} and the coded picture size is equal to input/decoded picture size. The secondary components are coded conditionally, using x_{Y} as auxiliary information from primary component for encoding x_{UV} and using ŷ_{Y} as a latent tensor with auxiliary information from primary component for decoding ŷ_{UV} reconstruction. The codec structure for primary component and secondary components are almost identical except the number of channels, size of the channels and the several entropy models for transforming latent tensor to bitstream, therefore primary and secondary latent tensor will generate two different bitstream based on two different entropy models. Prior to the encoding x_{Y}, x_{UV} goes through a module which adjusts the sample location by down-sampling (marked as “s↓” on FIG. 8), this essentially means that coded picture size for secondary component is different from the coded picture size for primary component. The scaling factor s is variable, but the default scaling factor is s=2. The size of auxiliary input tensor in conditional coding is adjusted in order the encoder receives primary and secondary components tensor with the same picture size. After reconstruction, the secondary component is rescaled to the original picture size with a neural-network based upsampling filter module (“NN-color filter s↑” on FIG. 8), which outputs secondary components up-sampled with factor s.

The example in FIG. 8 exemplifies an image coding system, where the input image is first transformed into primary (Y) and secondary components (UV). The outputs \hat{x}_{Y}, \hat{x}_{UV} are the reconstructed outputs corresponding to the primary and secondary components. At the and of the processing, \hat{x}_{Y}, \hat{x}_{UV} are converted back to RGB color format. Typically the x_{UV} is downsampled (resized) before processing with the encoding and decoding modules (neural networks). For example the size of the x_{UV} might be reduced by a factor of 50% in each of the vertical and horizontal dimensions. Therefore the processing of the secondary component includes approximately 50% x 50%=25% less samples, therefore it is computationally less complex.

### 2.8 Cropping Operation in Neural Network Based Coding

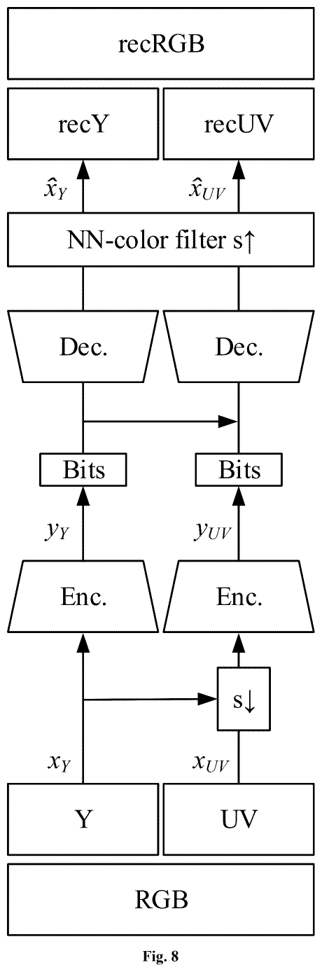

FIG. 9 illustrates an example synthesis transform for learning based image coding.

The example synthesis transform above includes a sequence of 4 convolutions with up-sampling with stride of 2. The synthesis transform sub-Net is depicted on FIG. 9. The size of the tensor in different parts of synthesis transform before cropping layer is the diagram on FIG. 9.

The cropping layer changes tensor size h_{d}×w_{d} to h_{d-1}×w_{d-1}, where h_{d}=2·ceil(H/2^{d}); w_{d}=2·ceil (W/2^{d}); here d is the depth of proceeding convolution in the codec architecture. For primary component Synthesis Transform receives input tensor with size of h×w, where h=ceil(H/16); w=ceil(W/16). The output of Synthesis Transform for primary component is 1×h₀×w₀, where h₀=H; h₀=W.

For secondary component Synthesis Transform receives input tensor with size h_{UV}×w_{UV}; h_{UV}=ceil(ceil(H/s)/16); w_{UV}=ceil(ceil(W/s)/16). The output of the Synthesis Transform for primary component is 2×h_{UV0}×w_{UV0}, where h_{UV0}=ceil(H/s); h_{UV0}=ceil(W/s). For secondary components input sizes are h₀=ceil(H/s); w₀=ceil(W/s), where s is the scale factor. The scale factor might be 2 for example, wherein the secondary component is downsampled by a factor of 2.

Based on the above explanation, the operation of the cropping layers depend on the output size H, W and the depth of the cropping layer. The depth of the left-most cropping layer in FIG. 9 is equal to 0. The output of this cropping layer must be equal to H, W (the output size), if the size of the input of this cropping layer is greater than H or W in horizontal or vertical dimension respectively, cropping needs to be performed in that dimension. The second cropping layer counting from left to right has a depth of 1. The output of the second cropping layer must be equal to h₁=2·ceil(H/2¹); w₁=2·ceil (W/2¹), which means if the input of this second cropping layer is greater than h1, w1 in any dimension, than cropping is applied in that dimension. In summary, the operation of cropping layers are controlled by the output size H,W. In one example if H and W are both equal to 16, then the cropping layers do not perform any cropping. On the other hand if H and W are both equal to 17, then all 4 cropping layers are going to perform cropping.

### 2.9 Bitwise Shifting

The bitwise shift operator can be represented using the function bitshift(x, n), where n is an integer number. If n is greater than 0, it corresponds to right-shift operator (>>), which moves the bits of the input to the right, and the left-shift operator (<<), which moves the bits to the left. In other words the bitshift(x, n) operation corresponds to:

$$bitshift ( x , n ) = x * {2}^{n}$$

$$or$$

$$bitshift ( x , n ) = floor ( x * {2}^{n} )$$

$$or$$

$$bitshift ( x , n ) = x // {2}^{n}$$

The output of the bitshift operation is an integer value. In some implementations, the floor( ) function might be added to the definition.

floor (x) is equal to the largest integer less than or equal to x.

The “//” operator or the integer division operator. It is an operation that comprises division and truncation of the result toward zero. For example, 7/4 and −7/−4 are truncated to 1 and −7/4 and 7/−4 are truncated to −1.

$$rightshift ( x , n ) = x >> n or$$

$$leftshift ( x , n ) = x << n$$

Equation 3: alternative implementation of the bitshift operator as rightshift or leftshift.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

### 2.10 Convolution Operation

The convolution operation starts with a kernel, which is a small matrix of weights. This kernel “slides” over the input data, performing an elementwise multiplication with the part of the input it is currently on, and then summing up the results into a single output pixel. In some cases, the convolution operation might comprise a “bias”, which is added to the output of the elementwise multiplication operation.

The convolution operation may be described by the following mathematical formula. An output out1 can be obtained as:

$$out 1 [ x , y ] = conv 1 ( I ) = {\sum }_{k = 0}^{M} {\sum }_{i = 0}^{N} {\sum }_{j = 0}^{P} w {1}_{k} [ i , j ] \times {I}_{k} [ x + i , y + j ] + K 1$$

where w1 are the multiplication factors, K1 is called a bias (an additive term), Iₖ is the kth input, N is the kernel size in one direction and P is the kernel size in another direction. The convolution layer might comprise convolution operations wherein more than one output might be generated. Other equivalent depictions of the convolution operation might be found below:

$$out 1 [ x , y ] = conv 1 ( I ) = {\sum }_{k = 0}^{M} {\sum }_{i = 0}^{N} {\sum }_{j = 0}^{P} w 1 [ k , i , j ] \times I [ k , x + i , y + j ] + K 1$$

$$out [ c , x , y ] = conv ( I ) = {\sum }_{k = 0}^{M} {\sum }_{i = 0}^{N} {\sum }_{j = 0}^{P} w [ c , k , i , j ] \times I [ k , x + i , y + j ] + K [ c ]$$

In the above equations “c” indicates the channel number. It is equivalent to output number, out[1,x,y] is one output and out[2,x,y] is a second output. The k is the input number, I[1, x, y] is one input, and I[2, x, y] is a second input. The w1, or w describe weights of the convolution operation.

### 2.10.1 Two Dimensional Convolution Operation

The convolution operation can be defined in 1, 2, 3, 4, . . . dimensions. As an example, the 2D convolution operation can be defined as:

$$out 1 [ x , y ] = conv 1 ( I ) = {\sum }_{i = 0}^{N} {\sum }_{j = 0}^{P} w {1}_{k} [ i , j ] \times {I}_{k} [ x + i , y + j ] + K 1$$

### 2.11 LeakyReLU Activation Function

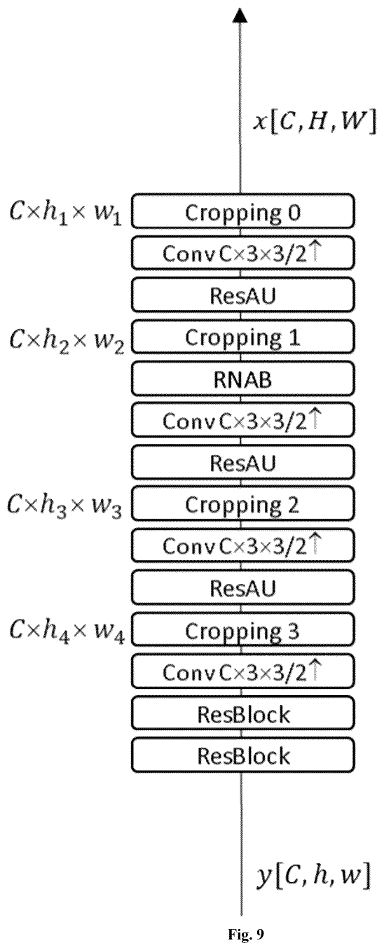

FIG. 10 illustrates an example Leaky ReLU activation function. The LeakyReLU activation function is depicted in FIG. 10. According to the function, if the input is a positive value, the output is equal to the input. If the input (y) is a negative value, the output is equal to a*y. The a is typically (not limited to) a value that is smaller than 1 and greater than 0. Since the multiplier a is smaller than 1, it can be implemented either as a multiplication with a non-integer number, or with a division operation. The multiplier a might be called the negative slope of the LeakyReLU function.

### 2.12 ReLU Activation Function

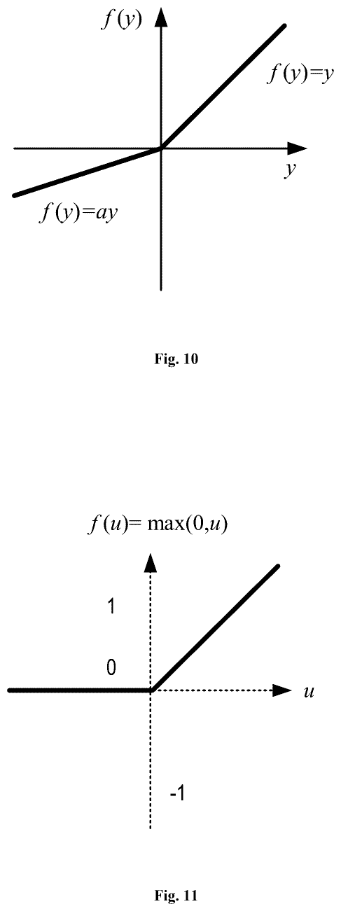

FIG. 11 illustrates an example ReLU activation function. The ReLU activation function is depicted in FIG. 11. According to the function, if the input is a positive value, the output is equal to the input. If the input (v) is a non-positive value, the output is equal to 0.

### 2.13 Pixel Shuffle and Unshuffle Functions

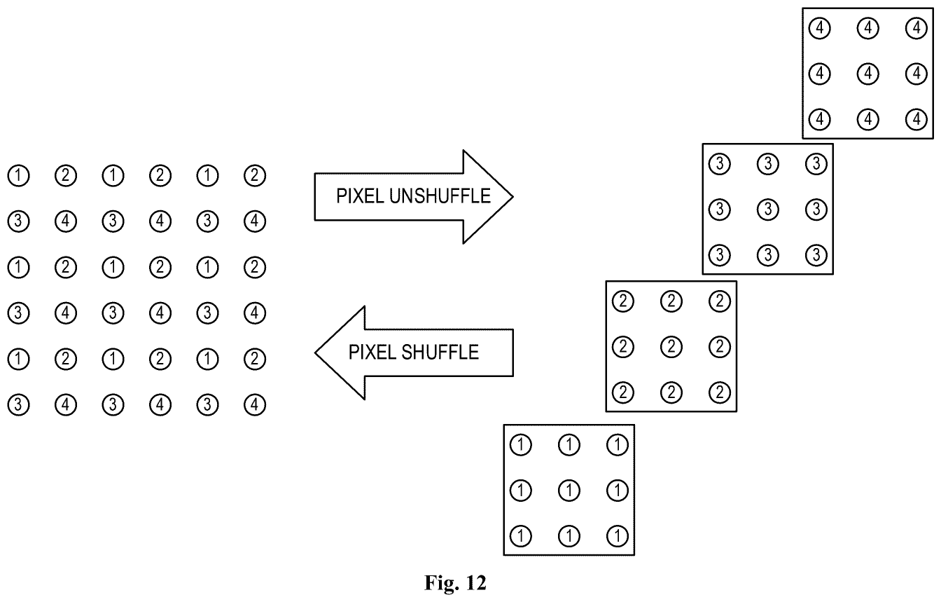

FIG. 12 illustrates an example of the pixel shuffle and unshuffle operations. PixelShuffle is an operation used in super-resolution models to implement efficient sub-pixel convolutions with a stride of l/r. Specifically, it rearranges elements in a tensor of shape [Cxr2, W, H] to a tensor of shape [C, Wxr, Hxr]. Pixel unshuffled operation is the opposite of shuffle operation, wherein the input tensor with shape [C, Wxr, Hxr] is converted to a tensor with shape [Cxr2, W, H].

### 2.14 Deconvolution Operation

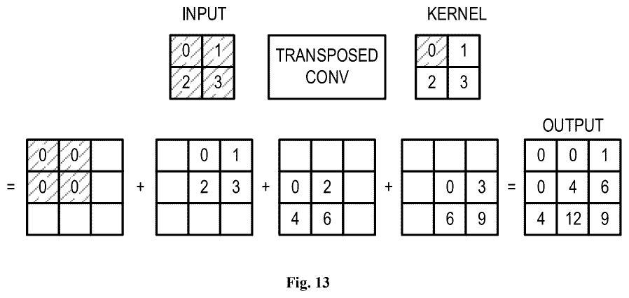

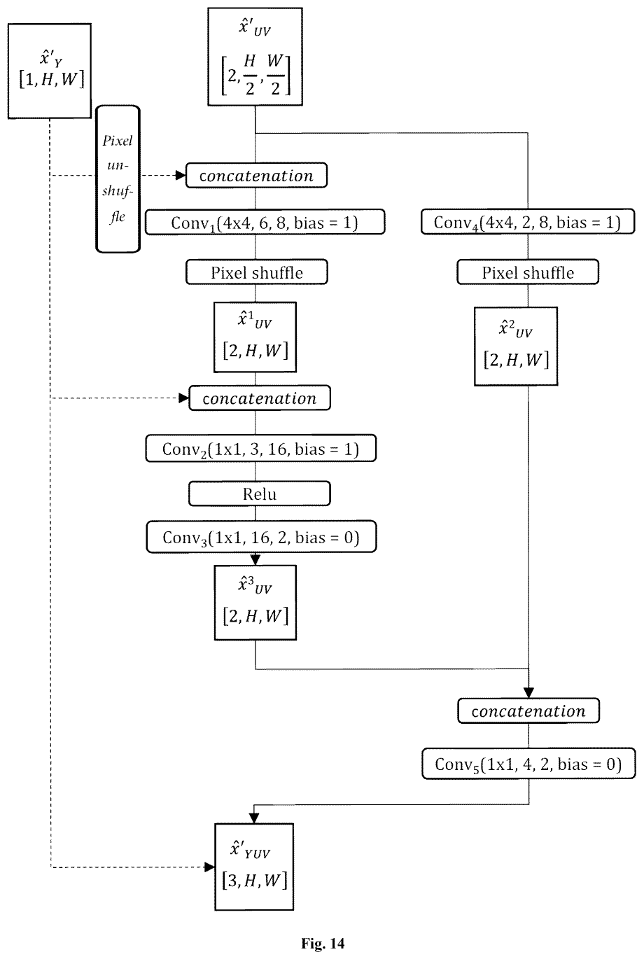

A transposed convolutional (aka deconvolution) layer, is usually carried out for upsampling i.e. to generate an output feature map that has a spatial dimension greater than that of the input feature map. Transposed convolution operation is exemplified in FIG. 13. FIG. 13 illustrates an example of a transposed convolution with a 2×2 kernel. The shaded portions are a portion of an intermediate tensor as well as the input and kernel tensor elements used for the computation. FIG. 14 illustrates an example Enhancement Filtering Extensions (EFE) filtering process.

### 3. Technical Problems Solved by Disclosed Technical Solutions

### 3.1 Example Problem

Many video and image compression schemes cannot adapt to changes in content, decoding device type, and decoding device conditions. The bitstream is encoded once and the same output must be obtained by all decoding devices. This means the compression scheme must be designed for the worst case, e.g., a device that is the least capable.

However, a bitstream might be received by many different types of decoding devices. The decoding device might have more capabilities in terms of:
Computational resource,
Power (In the worst case the device might be battery operated, whereas many devices might be connected to power source).

Furthermore, the video and image compression scheme must be designed for the worst-case application requirements.
The decoding time must be designed for fast decoding, although many applications can tolerate much higher decoding times.
   For example, application that requires fast browsing of images would require fast decoding of images.
   On the other hand, an image storage application might require images to be stored and displayed in highest quality. In this application, decoding time would not be a big concern.
The decoding time must be designed for the most challenging content (e.g., an image that has very large spatial size). An image with a very large size, for example, would require the highest decoding time, whereas a small image might require much lower decoding time.

As a result, video and image compression scheme generally must be designed for the worst case scenario, e.g., for the most incapable decoding device on the market and the most challenging application. Therefore, technologies providing higher compression efficiency are generally left out.

### 3.1 Further Problem Details

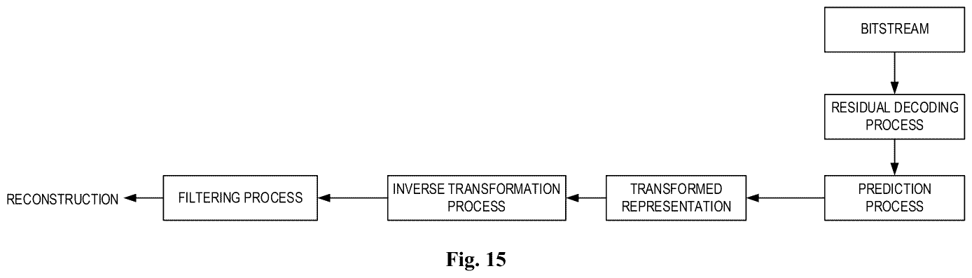

FIG. 15 illustrates an example image and/or video compression scheme. A bitstream is obtained, which comprise the residual information. The residual information is obtained by a lossless decoding method such as entropy decoding, arithmetic decoding, or other types of lossless decoding method. The residual information is used by a prediction method to obtain the transformed samples (transformed representation). The prediction method might be a simple one, for example, it might include adding the residual samples to mean samples (predicted samples). Or it might be auto-regressive. In this case, the predicted samples are obtained according to previously obtained transformed samples. In other words, in the auto-regressive prediction method, the first part of the transformed samples is obtained. The obtained part of the transformed samples is used to generate prediction samples, which are combined with part of the residual samples to obtain a second part of the transformed samples. In the auto-regressive prediction method, output is generated step by step. In each step, previously generated output might be used to obtain the output of the next step.

After the prediction method, an inverse transform is applied to convert the transformed representation to a reconstructed image. Finally, a filtering method might be obtained.

In the method in FIG. 15, therefore, only one reconstructed image is obtained by the decoder.

### 4.A Listing of Solutions and Embodiments

### 4.1 Central Examples

According to an example, one bitstream is generated by the encoder and transmitted to the decoder. The decoder has the option to decompress the bitstream in at least two different ways (using at least two different decompression processes) to obtain at least 2 different reconstructions (e.g., decoded images). The decoder might choose to apply the decoding method based on its resources (e.g., computational and power resources), and/or based on the requirements of the application.

### Encoder Operation:

According to an example, an image is converted to a bitstream, wherein the bitstream can be decompressed into at least two different reconstructions.

### Decoder Operation:

According to an example, a bitstream is converted to at least two reconstructed images using a decompression method.

### 4.2 Details of the Examples

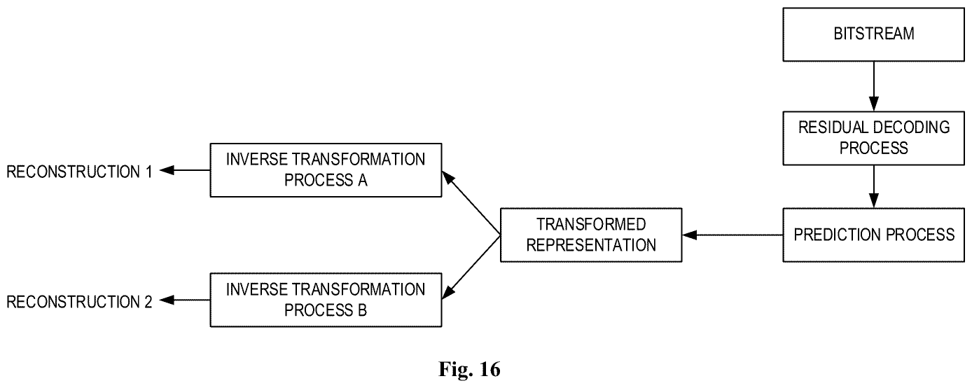

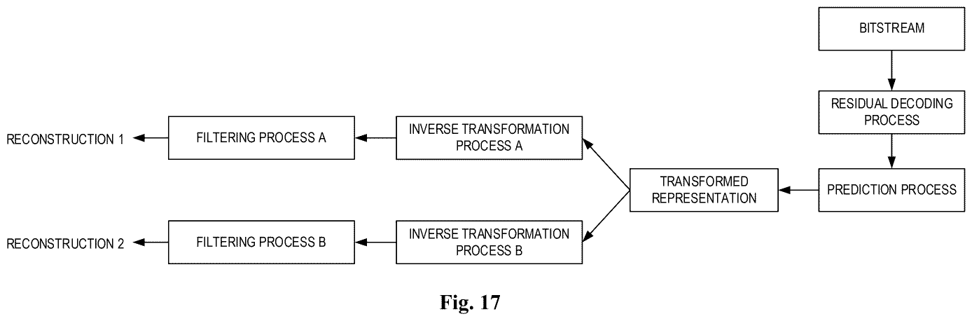

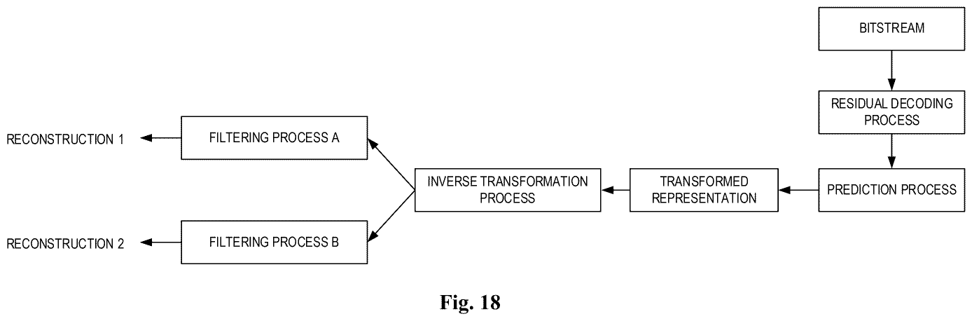

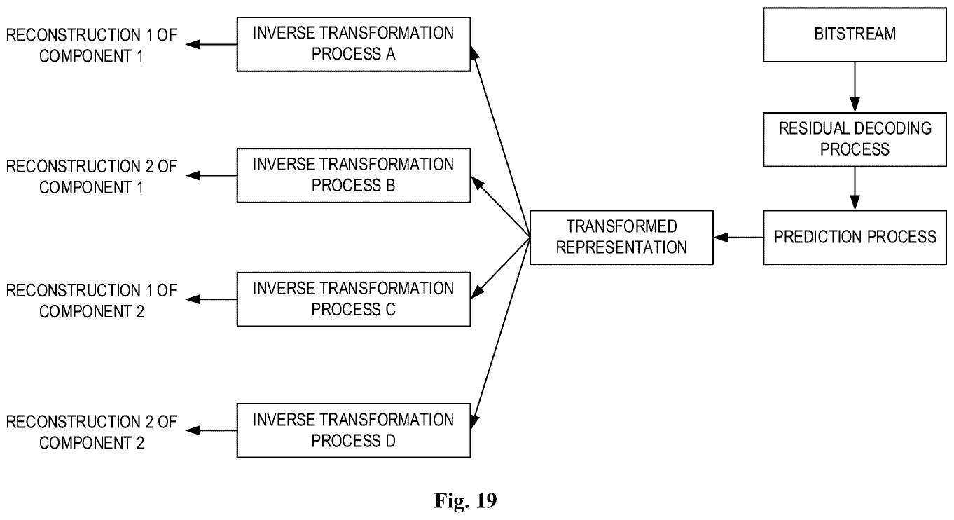

FIG. 16 illustrates an example implementation of a video compression scheme for performing the disclosed examples. According to an example, a bitstream is obtained by the decoder, which is processed by residual decoding and prediction processes to obtain transformed representation (e.g., latent representation). Afterwards, it is processed by a first inverse transformation process (inverse transformation process A) to obtain a first reconstruction and/or it processed by a second inverse transformation method (inverse transformation process B) to obtain a second reconstruction.
FIG. 17 illustrates an example implementation of a video compression scheme for performing the disclosed examples. According to an example, a bitstream is obtained by the decoder. Compared to the example in FIG. 16, in FIG. 17 a filtering method is applied after the inverse transformation process. According to an example:
   A filtering method might be applied to one of the at least two reconstructions.
   A filtering method might be applied to one of the at least two reconstructions and no filtering might be applied to the other reconstruction.
   A same filtering method might be applied to two of the at least two reconstructions.
   Different number of filtering operations might be applied to the at least two reconstructions.
   A first filtering method (filtering method A) might be applied to the first reconstruction and a second filtering method (filtering method B) might be applied to the second reconstruction.
FIG. 18 illustrates an example implementation of a video compression scheme for performing the disclosed examples. According to the example, a bitstream is obtained by the decoder. Residual decoding process, prediction process, and inverse transformation process are applied to obtain an intermediate reconstruction. The intermediate reconstruction might be processed by two filtering methods (filtering process A and filtering process B) to obtain 2 final reconstructions.
   The filtering process A and B might comprise different filtering processes.
      In one example filtering process might be an EFE filtering process (exemplified in FIG. 14).
      In another example filtering process might be an ICCI filtering process.
   The filtering process A and B might comprise different number of filtering processes. For example process A might comprise filtering steps of filtering process B and additionally include further process steps.
   The filtering processes A and B might be same processes, however the side information (parameters of the filtering process) might be different.
FIG. 19 illustrates an example implementation of a video compression scheme for performing the disclosed examples. According to the example, a bitstream is obtained by the decoder, which is processed by residual decoding and prediction processes to obtain transformed representation (e.g., latent representation). Afterwards, the latent samples (transformed coefficients) are processed by at least three inverse transformation processes.
   In an example,
      Inverse transformation A might be used to obtain first reconstruction of the first component.
      Inverse transformation B might be used to obtain second reconstruction of the first component.
      Inverse transformation C might be used to obtain reconstruction of the second component.
      A first reconstruction might be obtained based on the first reconstruction of first component and reconstruction of the second component.
      A second reconstruction might be obtained based on the second reconstruction of first component and reconstruction of the second component.
In another example,
   Inverse transformation A might be used to obtain first reconstruction of the first component.
   Inverse transformation B might be used to obtain second reconstruction of the first component.
   Inverse transformation C might be used to obtain first reconstruction of the second component.
   Inverse transformation D might be used to obtain second reconstruction of the second component.
   The first reconstruction or the second reconstruction might be obtained based either one of:
      the first reconstruction of first component and first reconstruction of the second component.
      the second reconstruction of first component and first reconstruction of the second component.
      the first reconstruction of first component and second reconstruction of the second component.
      the second reconstruction of first component and second reconstruction of the second component.
The first component and second component might be a luma component of an image.
The first component and second component might be a chroma component of an image.
The reconstruction might be a reconstructed image. It might compromise more than more components.
   In All of the examples above,
The inverse transformation method might be:
   a synthesis transform.
   a neural network based transform.
      The inverse transformation might comprise convolution, deconvolution (transposed convolution) and activation layers.
   an inverse DCT or a KLT transform.
   an inverse primary or a secondary transform.
   The first inverse transformation might be a complex one, whereas the second inverse transformation might be a simpler one. The complexity of the inverse transformations might be determined based on:
      number of Processing layers,
      KMAC (kilo multiplication-accumulation). In other words, the number of multiplications and accumulation operations that need to be performed.
The reconstruction might be:
   a reconstructed image.
   a reconstructed luma component of an image.
   a reconstructed chroma component of an image.
   a reconstructed Y (luma), Cb (blue difference) component or Cr (red difference) component of an image.
   A be R (red), G (Green) or B (Blue) components of a reconstructed image.
The filtering method:
   A cross component filter.
   An EFE (Enhancement Filtering Extensions) filter:
      The operation might be similar to the FIG. 14.
The filtering process A and/or B might be:
   The filtering process A and/or B might comprise different filtering processes.
      In one example filtering process might be an EFE filtering process (exemplified in FIG. 14).
      In another example filtering process might be an ICCI filtering process.
   The filtering process A and/or B might comprise different number of filtering processes. For example, process A might comprise filtering steps of filtering process B and additionally include further process steps.
   The filtering processes A and B might be same processes, however the side information (parameters of the filtering process) might be different.
   In one example, filtering process A might exist, but another filtering process might not exist. In other words, a first intermediate reconstruction might be processed by a filtering process. However, second intermediate reconstruction is not processed by a filtering process and is considered as the final reconstruction.
An indication might be included in the bitstream (or obtained from a bitstream) to indicate the quality of the first reconstruction and the second reconstruction.
   The quality indication might be PSNR (peak signal to noise ratio), MSSSIM Multi-scale Structural Similarity Index Measure), VMAF (Video Multi-Method Assessment Fusion), VIF (Visual information fidelity), FSIM (feature similarity index measure), SSIM (Structural Similarity Index Measure), or a similar metric for assessing quality of an image or a video.
   The indication might compromise quality information for the first reconstruction and/or the second reconstruction.
   The decoder might choose to obtain only one of the available reconstructions. The decision of which reconstruction to obtain might be based on the said indication.

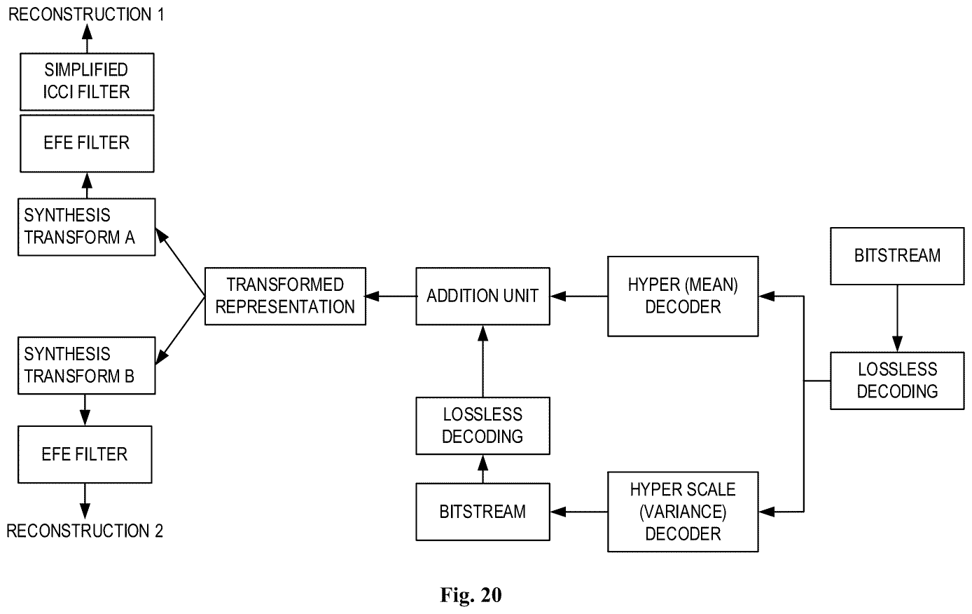

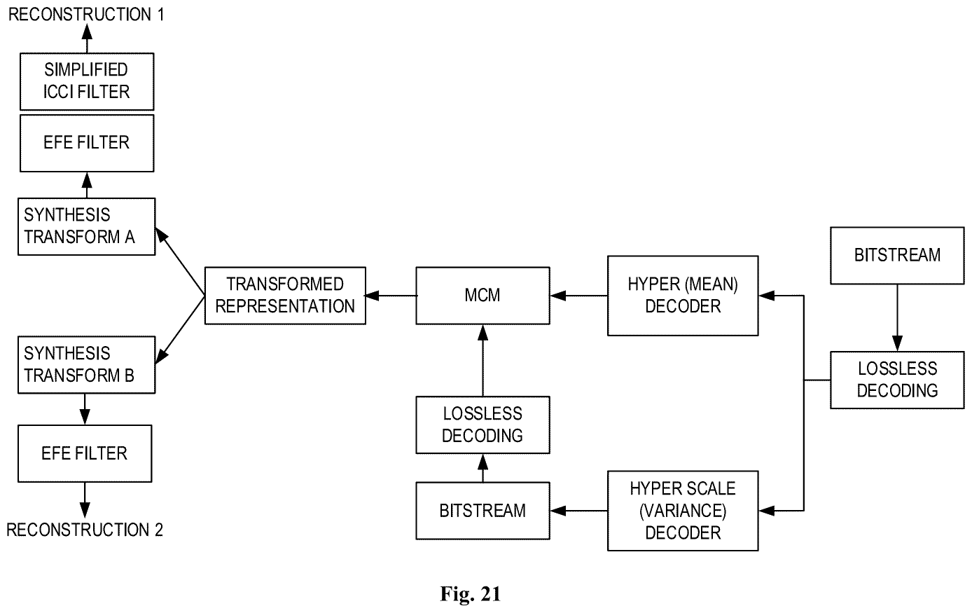

FIG. 20 illustrates an example implementation of a video compression scheme for performing the disclosed examples. FIG. 21 illustrates an example implementation of a video compression scheme for performing the disclosed examples. In the examples hyper scale decoder (or the hyper variance decoder) might be the unit that is part of the entropy decoding process. The hyper scale decoder module is used by the lossless decoding module to decode the bitstream to obtain residual information. The residual information and the output of the hyper decoder are combined by either an addition unit (FIG. 20) or an MCM (multi-state context module, FIG. 21) unit to obtain the transformed samples. Afterwards the decoder has two options:
1. The decoder might choose to apply synthesis transform A, EFE filter and ICCI filter. This branch might be computationally more complex, and it might result in a reconstruction that has higher quality.
2. The decoder might choose to apply synthesis transform B and EFE filter. The side information (control parameters) of the EFE filter might be same or different in the two branches. An example implementation of the EFE filter might be similar to FIG. 14.

The difference between the examples in FIGS. 20 and 21 is the MCM (multi-state context module). The MCM module or the addition unit are part of the prediction process, they represent different alternatives. The addition unit is a simple method of combining the prediction and the residual data to obtain transformed samples. The MCM is an auto-regressive (explained above) method, wherein the transformed samples are obtained in a step-by step fashion.

### 4.3. Explanation and the Benefits of the Examples

The target of the disclosure is a decompression method that is scalable in the complexity dimension.

When the encoder encodes (compresses) an image, typically it does not know what kind of decoding device will decode it. As a result, a codec (compression/decompression) process is designed in such a way that the least capable device and the most demanding application can be supported. However, this leaves a lot of unexploited potential.

The design provides a compression/decompression method, wherein a single bitstream can be decoded using 2 different ways by the decoder. The decoder can choose which way to decode the bitstream based on application requirements and device capabilities and the device condition.
In one of the decompression ways, the reconstructed image might be lower quality, however the reconstruction process might be very fast. This way is suitable for mobile phones, for example. Mobiles phones typically have less computational power compared to a laptop computer. Moreover, since mobile phones are battery operated, the energy consumption of the decompression process is important, therefore a mobile phone can choose to use the fast decompression way.
If the device is a more capable device however, that is connected to a power outlet (like a laptop device), it can select the higher quality decompression way. Therefore, it obtains a higher quality image from the same bitstream.
Another example is related to the application requirements. In an image storage application for example, the user typically has two viewing modes. The first mode is browsing mode, wherein many pictures are displayed in quick succession to the viewer. In this mode the device can choose to apply the fast decompression way, as the quality of the displayed image is not so important. The second mode is detailed viewing mode, where the user selects an image for more detailed viewing. In this mode, high quality decompression way can be applied by the decoding device to obtain a better quality image.

As a summary, the disclosure provides a compression decompression method, where the decoder is provided with at least two ways of decoding a single image. The decoder can select between the two ways based on its capabilities and the application requirements.

More details of the embodiments of the present disclosure will be described below which are related to neural network-based visual data coding. As used herein, the term “visual data” may refer to a video, an image, a picture in a video, or any other visual data suitable to be coded.

As discussed above, in the existing design for neural network (NN)-based visual data coding, a bitstream for an image may be decoded to obtain only one reconstruction of the image. That is, the bitstream supports only one specific decoding profile. In this case, this decoding profile must be designed for the worst case scenario, e.g., for the most incapable decoding device on the market and the most challenging application. Therefore, technologies providing higher compression efficiency cannot be fully utilized.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

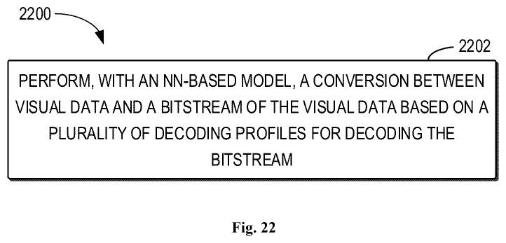

FIG. 22 illustrates a flowchart of a method 2200 for visual data processing in accordance with some embodiments of the present disclosure. At 2202, a conversion between visual data and a bitstream of the visual data is performed with a neural network (NN)-based model based on a plurality of decoding profiles for decoding the bitstream. In some embodiments, the conversion may include encoding the visual data into the bitstream. Additionally or alternatively, the conversion may include decoding the visual data from the bitstream. The scope of the present disclosure is not limited in this respect.

As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. In some embodiments, the NN-based model may be an end-to-end visual data codec.

It should be understood that the possible implementations of the NN-based model described here are merely illustrative and therefore should not be construed as limiting the present disclosure in any way.

The plurality of decoding profiles are configured for decoding the same bitstream and are different from each other. For example, a decoding profile may be a specific decoding configuration, e.g., a specific structure of the NN-based model, a specific decoding scheme, or the like. In addition, a decoding profile may correspond to a specific reconstruction of the visual data. By way of example different reconstructions of the visual data corresponding to the plurality of decoding profiles may have different qualities. If a bitstream is allowed to be decoded based on a specific decoding profile, this decoding profile may be descried as being supported by the bitstream. In some embodiments, each of the plurality of decoding profiles may be supported by the bitstream. Alternatively, one or more decoding profiles in the plurality of decoding profiles may be supported by the bitstream.

By way of example, a same encoding profile may be used to encoding the visual data into a bitstream, and this bitstream may be allowed to be decoded based on the plurality of decoding profiles. In practice, one or more decoding profiles may be selected from the plurality of decoding profiles and used to decode the profile. This will be descried in detail below.

In view of the above, a bitstream may be decoded based on a plurality of different decoding profiles. Compared with the conventional solution where the bitstream supports only one specific decoding profile, the proposed method can advantageously enable a selection of the decoding profile for decoding the bitstream, e.g., based on capability of a decoder and/or the application requirement. Thereby, the coding flexibility can be improved and thus the coding efficiency can be enhanced.

In some embodiments, if a first decoding profile in the plurality of decoding profiles is used to decode the bitstream, a first reconstruction of the visual data may be obtained by applying a first inverse transformation process to a reconstructed latent representation of the visual data. If a second decoding profile in the plurality of decoding profiles may be used to decode the bitstream, a second reconstruction of the visual data may be obtained by applying a second inverse transformation process to the reconstructed latent representation. The second decoding profile is different from the first decoding profile. As used herein, the term “latent representation” may refer to an intermediate representation of the visual data during the conversion process, and may also be referred to as a “transformed representation”. By way of example rather than limitation, the latent representation may comprise a latent tensor.

By way of example, the reconstructed latent representation of the visual data may be obtained by applying a residual decoding process and a prediction process to the bitstream. As shown in FIGS. 16-18. the residual decoding process may be applied to bitstream to obtain residual information from the bitstream, and the prediction process may be further applied to the residual information to reconstruct the latent representation of the visual data. For example, the reconstructed latent representation of the visual data may be obtained by applying a multi-stage context model (MCM) and/or an addition unit in the prediction process, as shown in FIGS. 20 and 21. The multi-stage context model may also be referred to as multi-state context module or the like.

In some embodiments, each of the first reconstruction and the second reconstruction may be decoded or decompressed visual data. Additionally, a size of the first reconstruction may be the same as the second reconstruction. For example, a width and/or a height of the first reconstruction may be the same as the second reconstruction. In some embodiments, each of the first reconstruction and the second reconstruction may comprise 3 components. By way of example, each of the first reconstruction and the second reconstruction may be in a red-green-blue (RGB) color format or a YUV color format. Moreover, samples of each of the first reconstruction and the second reconstruction may be visual representations to be displayed.

In some embodiments, the second inverse transformation process may be different from the first inverse transformation process. This is shown in FIGS. 16 and 17. Alternatively, the second inverse transformation process may be the same as the first inverse transformation process. This is shown in FIG. 18.

In some additional embodiments, if the first decoding profile is used to decode the bitstream, a first filtering process may be applied to the first reconstruction. If the second decoding profile is used to decode the bitstream, a second filtering process may be applied to the second reconstruction. This is shown in FIGS. 17 and 18.

In some embodiments, the first filtering process may be the same as the second filtering process. Alternatively, the first filtering process may be different from the second filtering process. In one example embodiment, the first filtering process may comprise a first number of filtering operations, the second filtering process may comprise a second number of filtering operations, and the second number may be different from the first number. For example, the first filtering process may comprise all filtering operations of the second filtering process and at least one further filtering operation.

Alternatively, the first filtering process may comprise an enhancement filtering process and the second filtering process may comprise an inter channel correlation information (ICCI) filtering process. An example structure of the enhancement filtering process is shown in FIG. 14. It should be understood that the structure of the enhancement filtering process shown in FIG. 14 is only illustrative and the enhancement filtering process may be implemented in any other suitable manner. Furthermore, the first filtering process and/or the second filtering process may comprise any other suitable filtering process, such as a cross-component-based filtering process. The scope of the present disclosure is not limited in this respect.

In some further embodiments, a structure of the first filtering process may be the same as the second filtering process, while one or more parameters of the first filtering process may be different from the second filtering process.

In some alternative embodiments, if the first decoding profile is used to decode the bitstream, a filtering process may be applied to the first reconstruction. If the second decoding profile is used to decode the bitstream, no filtering process may be applied to the second reconstruction.

In some embodiments, the first inverse transformation process may comprise a first inverse transformation sub-process for a first component of the visual data and a second inverse transformation sub-process for a second component of the visual data. In addition, the second inverse transformation process may comprise a third inverse transformation sub-process for the first component and a fourth inverse transformation sub-process for the second component. With reference to FIG. 19, the first inverse transformation sub-process may correspond to the inverse transformation process A: the second inverse transformation sub-process may correspond to the inverse transformation process C: the third inverse transformation sub-process may correspond to the inverse transformation process B; and the fourth inverse transformation sub-process may correspond to the inverse transformation process D.

The second component is different from the first component. For example, the first component may be a chroma component and the second component may be a luma component. Alternatively, the first component may be a luma component and the second component may be a chroma component. In another example, the first component may be a primary component and the second component may be a secondary component. In a further example, the first component may be a secondary component and the second component may be a primary component. In a still further example, the first component may be a red (R) component, and the second component may be a blue (B) component. It should be understood that the possible implementations of the first and second components described here are merely illustrative and therefore should not be construed as limiting the present disclosure in any way.

In some embodiments, the first inverse transformation sub-process may be different from the second inverse transformation sub-process, and the third inverse transformation sub-process may be different from the fourth inverse transformation sub-process. Additionally or alternatively, the first inverse transformation sub-process may be different from the third inverse transformation sub-process, and the second inverse transformation sub-process may be different from the fourth inverse transformation sub-process.

In some embodiments, an inverse transformation may comprise a synthesis transform. In this case, the above-mentioned inverse transformation process is a process of synthesis transform, and the above-mentioned inverse transformation sub-process is a sub-process of synthesis transform. It should be noted that both a process of synthesis transform and a sub-process of synthesis transform may be referred to a synthesis transform for short.

In some embodiments, an inverse transformation (e.g., the synthesis transform) may comprise a convolution layer, a transposed convolution layer, an activation layer, and/or the like.

In some alternative embodiments, an inverse transformation may comprise a discrete cosine transform (DCT) a Karhunen-Loève transform (KLT), or the like.

In some embodiments, a complexity of the first inverse transformation process may be higher than the second inverse transformation process, or vice versa. The complexity of the inverse transformations may be determined based on the number of processing layers and/or KMAC (kilo multiplication-accumulation).

In some embodiments, the bitstream may comprise one or more indications indicating at least one of the following: a quality of the first reconstruction of the visual data, or a quality of the second reconstruction of the visual data. By way of example, at least one of the quality of the first reconstruction or the quality of the second reconstruction may be determined based on one of the following metrics: a peak signal to noise ratio (PSNR), a multi-scale structural similarity index measure (MS-SSIM), a video multi-method assessment fusion (VMAF), a visual information fidelity (VIF), a feature similarity index measure (FSIM), or a structural similarity index measure (SSIM). It should be understood that the above examples are described merely for purpose of description. The scope of the present disclosure is not limited in this respect.

In some embodiments, a decoding profile may be selected from the plurality of decoding profiles based on the at least one indication and may be used to decode the bitstream.

In some embodiments, if a third decoding profile in the plurality of decoding profiles is used to decode the bitstream, a reconstructed latent representation of the visual data may be determined based on a first prediction process. If a fourth decoding profile in the plurality of decoding profiles is used to decode the bitstream, a reconstructed latent representation of the visual data may be determined based on a second prediction process. The fourth decoding profile may be different from the third decoding profile and the second prediction process may be different from the first prediction process.

By way of example rather than limitation, in the first prediction process, residual information obtained from the bitstream and an output of a hyper decoder in the NN-based model may be combined with an MCM. By way of example, with reference to FIG. 21, the residual information is decoded from the bitstream based on an output of the hyper scale decoder (such as, variance information or the like). Then, the residual information is combined with an output of the hyper decoder (such as, mean) by using the MCM to reconstruct the latent representation.

Moreover, in the second prediction process, the residual information and the output of the hyper decoder may be combined with an addition unit. By way of example, with reference to FIG. 20, the residual information is decoded from the bitstream based on an output of the hyper scale decoder (such as, variance information or the like). Then, the residual information is combined with an output of the hyper decoder (such as, mean) by using the addition unit to reconstruct the latent representation.

In some embodiments, at 2202, a decoding profile is selected from the plurality of decoding profiles. For example, the decoding profile may be selected based on resources of a decoder for performing the conversion, a requirement for performing the conversion, and/or the like. This has been described in detail in the above section 4.3. Moreover, the conversion is performed based on the selected decoding profile. Thereby, the plurality of different decoding profiles may be selected and used depending on the specific application scenario, which improves the coding flexibility.

In view of the above, the solutions in accordance with some embodiments of the present disclosure can advantageously improve the coding flexibility, and thus enhance the coding efficiency.

According to further embodiments of the present disclosure, a non-transitory computer-readable recording medium is provided. The non-transitory computer-readable recording medium stores a bitstream of visual data which is generated by a method performed by an apparatus for visual data processing. In the method, a conversion between the visual data and the bitstream is performed with a neural network (NN)-based model based on a plurality of decoding profiles for decoding the bitstream. The plurality of decoding profiles are different from each other.

According to still further embodiments of the present disclosure, a method for storing bitstream of visual data is provided. In the method, the bitstream is generated with a neural network (NN)-based model based on a plurality of decoding profiles for decoding the bitstream. The plurality of decoding profiles are different from each other. Furthermore, the bitstream is stored in a non-transitory computer-readable recording medium.

Implementations of the present disclosure can be described in view of the following clauses, the features of which can be combined in any reasonable manner.

Clause 1. A method for visual data processing, comprising: performing, with a neural network (NN)-based model, a conversion between visual data and a bitstream of the visual data based on a plurality of decoding profiles for decoding the bitstream, the plurality of decoding profiles being different from each other.

Clause 2. The method of clause 1, wherein if a first decoding profile in the plurality of decoding profiles is used to decode the bitstream, a first reconstruction of the visual data is obtained by applying a first inverse transformation process to a reconstructed latent representation of the visual data, and if a second decoding profile in the plurality of decoding profiles is used to decode the bitstream, a second reconstruction of the visual data is obtained by applying a second inverse transformation process to the reconstructed latent representation, the second decoding profile being different from the first decoding profile.

Clause 3. The method of clause 2, wherein the second inverse transformation process is different from the first inverse transformation process.

Clause 4. The method of clause 2, wherein the second inverse transformation process is the same as the first inverse transformation process.

Clause 5. The method of any of clauses 2-4, wherein if the first decoding profile is used to decode the bitstream, a first filtering process is applied to the first reconstruction, and if the second decoding profile is used to decode the bitstream, a second filtering process is applied to the second reconstruction.

Clause 6. The method of clause 5, wherein the first filtering process is the same as the second filtering process.

Clause 7. The method of clause 5, wherein the first filtering process is different from the second filtering process.

Clause 8. The method of clause 7, wherein the first filtering process comprises a first number of filtering operations, the second filtering process comprises a second number of filtering operations, and the second number is different from the first number.

Clause 9. The method of clause 8, wherein the first filtering process comprises all filtering operations of the second filtering process and at least one further filtering operation.

Clause 10. The method of any of clauses 6-9, wherein the first filtering process comprises an enhancement filtering process, and the second filtering process comprises an inter channel correlation information (ICCI) filtering process.

Clause 11. The method of clause 5, wherein a structure of the first filtering process is the same as the second filtering process, and one or more parameters of the first filtering process are different from the second filtering process.

Clause 12. The method of any of clauses 2-4, wherein if the first decoding profile is used to decode the bitstream, a filtering process is applied to the first reconstruction, and if the second decoding profile is used to decode the bitstream, no filtering process is applied to the second reconstruction.

Clause 13. The method of any of clauses 2-12, wherein the first inverse transformation process comprises a first inverse transformation sub-process for a first component of the visual data and a second inverse transformation sub-process for a second component of the visual data, the second component being different from the first component, and the second inverse transformation process comprises a third inverse transformation sub-process for the first component and a fourth inverse transformation sub-process for the second component.

Clause 14. The method of clause 13, wherein the first component is a chroma component and the second component is a luma component, or the first component is a luma component and the second component is a chroma component.

Clause 15. The method of clause 13, wherein the first component is a primary component and the second component is a secondary component, or the first component is a secondary component and the second component is a primary component.

Clause 16. The method of any of clauses 13-15, wherein the first inverse transformation sub-process is different from the second inverse transformation sub-process, and the third inverse transformation sub-process is different from the fourth inverse transformation sub-process.

Clause 17. The method of any of clauses 13-16, wherein the first inverse transformation sub-process is different from the third inverse transformation sub-process, and the second inverse transformation sub-process is different from the fourth inverse transformation sub-process.

Clause 18. The method of any of clauses 2-17, wherein the reconstructed latent representation of the visual data is obtained by applying a residual decoding process and a prediction process to the bitstream.

Clause 19. The method of clause 18, wherein the reconstructed latent representation of the visual data is obtained by applying a multi-stage context model (MCM) in the prediction process.

Clause 20. The method of any of clauses 2-19, wherein an inverse transformation comprises a synthesis transform.

Clause 21. The method of any of clauses 2-20, wherein an inverse transformation comprises at least one of the following: a convolution layer, a transposed convolution layer, or an activation layer.

Clause 22. The method of any of clauses 2-19, wherein an inverse transformation comprises a discrete cosine transform (DCT) or a Karhunen-Loève transform (KLT).

Clause 23. The method of any of clauses 2-22, wherein a complexity of the first inverse transformation process is higher than the second inverse transformation process.

Clause 24. The method of any of clauses 2-23, wherein the bitstream comprises one or more indications indicating at least one of the following: a quality of the first reconstruction of the visual data, or a quality of the second reconstruction of the visual data.

Clause 25. The method of clause 24, wherein at least one of the quality of the first reconstruction or the quality of the second reconstruction is determined based on one of the following metrics: a peak signal to noise ratio (PSNR), a multi-scale structural similarity index measure (MS-SSIM), a video multi-method assessment fusion (VMAF), a visual information fidelity (VIF), a feature similarity index measure (FSIM), or a structural similarity index measure (SSIM).

Clause 26. The method of any of clauses 24-25, wherein a decoding profile is selected from the plurality of decoding profiles based on the at least one indication and is used to decode the bitstream.

Clause 27. The method of any of clauses 2-26, wherein each of the first reconstruction and the second reconstruction is decoded visual data.

Clause 28. The method of any of clauses 2-27, wherein a size of the first reconstruction is the same as the second reconstruction.

Clause 29. The method of any of clauses 2-28, wherein each of the first reconstruction and the second reconstruction comprises 3 components.

Clause 30. The method of clause 29, wherein each of the first reconstruction and the second reconstruction is in a red-green-blue (RGB) color format or a YUV color format.

Clause 31. The method of any of clauses 2-29, wherein samples of each of the first reconstruction and the second reconstruction are visual representations to be displayed.

Clause 32. The method of clause 1, wherein if a third decoding profile in the plurality of decoding profiles is used to decode the bitstream, a reconstructed latent representation of the visual data is determined based on a first prediction process, and if a fourth decoding profile in the plurality of decoding profiles is used to decode the bitstream, a reconstructed latent representation of the visual data is determined based on a second prediction process, the fourth decoding profile being different from the third decoding profile and the second prediction process being different from the first prediction process.

Clause 33. The method of clause 32, wherein in the first prediction process, residual information obtained from the bitstream and an output of a hyper decoder in the NN-based model are combined with an MCM, and in the second prediction process, the residual information and the output of the hyper decoder are combined with an addition unit.

Clause 34. The method of any of clauses 1-33, wherein performing the conversion comprises: selecting a decoding profile from the plurality of decoding profiles; and performing the conversion based on the selected decoding profile.

Clause 35. The method of clause 34, wherein the decoding profile is selected based on at least one of the following: resources of a decoder for performing the conversion, or a requirement for performing the conversion.

Clause 36. The method of any of clauses 1-35, wherein each of the plurality of decoding profiles is supported by the bitstream.

Clause 37. The method of any of clauses 1-36, wherein the visual data comprise a video, a picture of the video, or an image.

Clause 38. The method of any of clauses 1-37, wherein the conversion includes encoding the visual data into the bitstream.

Clause 39. The method of any of clauses 1-37, wherein the conversion includes decoding the visual data from the bitstream.

Clause 40. An apparatus for visual data processing comprising a processor and a non-transitory memory with instructions thereon, wherein the instructions upon execution by the processor, cause the processor to perform a method in accordance with any of clauses 1-39.

Clause 41. A non-transitory computer-readable storage medium storing instructions that cause a processor to perform a method in accordance with any of clauses 1-39.

Clause 42. A non-transitory computer-readable recording medium storing a bitstream of visual data which is generated by a method performed by an apparatus for visual data processing, wherein the method comprises: performing, with a neural network (NN)-based model, a conversion between the visual data and the bitstream based on a plurality of decoding profiles for decoding the bitstream, the plurality of decoding profiles being different from each other.

Clause 43. A method for storing a bitstream of visual data, comprising: generating, with a neural network (NN)-based model, the bitstream based on a plurality of decoding profiles for decoding the bitstream, the plurality of decoding profiles being different from each other; and storing the bitstream in a non-transitory computer-readable recording medium.

### Example Device

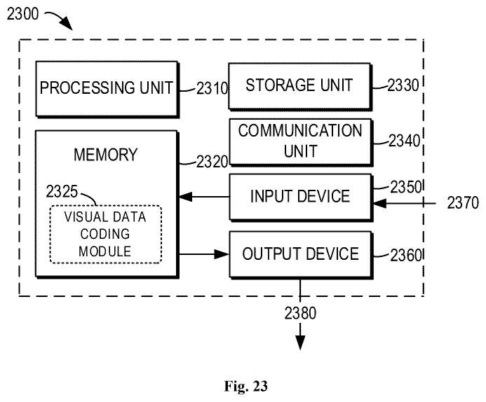

FIG. 23 illustrates a block diagram of a computing device 2300 in which various embodiments of the present disclosure can be implemented. The computing device 2300 may be implemented as or included in the source device 110 (or the visual data encoder 114) or the destination device 120 (or the visual data decoder 124).

It would be appreciated that the computing device 2300 shown in FIG. 23 is merely for purpose of illustration, without suggesting any limitation to the functions and scopes of the embodiments of the present disclosure in any manner.

As shown in FIG. 23, the computing device 2300 includes a general-purpose computing device 2300. The computing device 2300 may at least comprise one or more processors or processing units 2310, a memory 2320, a storage unit 2330, one or more communication units 2340, one or more input devices 2350, and one or more output devices 2360.

In some embodiments, the computing device 2300 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2300 can support any type of interface to a user (such as “wearable” circuitry and the like).

The processing unit 2310 may be a physical or virtual processor and can implement various processes based on programs stored in the memory 2320. In a multi-processor system, multiple processing units execute computer executable instructions in parallel so as to improve the parallel processing capability of the computing device 2300. The processing unit 2310 may also be referred to as a central processing unit (CPU), a microprocessor, a controller or a microcontroller.

The computing device 2300 typically includes various computer storage medium. Such medium can be any medium accessible by the computing device 2300, including, but not limited to, volatile and non-volatile medium, or detachable and non-detachable medium. The memory 2320 can be a volatile memory (for example, a register, cache, Random Access Memory (RAM)), a non-volatile memory (such as a Read-Only Memory (ROM). Electrically Erasable Programmable Read-Only Memory (EEPROM), or a flash memory), or any combination thereof. The storage unit 2330 may be any detachable or non-detachable medium and may include a machine-readable medium such as a memory, flash memory drive. magnetic disk or another other media, which can be used for storing information and/or visual data and can be accessed in the computing device 2300.

The computing device 2300) may further include additional detachable/non-detachable, volatile/non-volatile memory medium. Although not shown in FIG. 23, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 2340 communicates with a further computing device via the communication medium. In addition, the functions of the components in the computing device 2300 can be implemented by a single computing cluster or multiple computing machines that can communicate via communication connections. Therefore, the computing device 2300 can operate in a networked environment using a logical connection with one or more other servers, networked personal computers (PCs) or further general network nodes.

The input device 2350 may be one or more of a variety of input devices, such as a mouse, keyboard, tracking ball, voice-input device, and the like. The output device 2360 may be one or more of a variety of output devices, such as a display, loudspeaker, printer, and the like. By means of the communication unit 2340, the computing device 2300 can further communicate with one or more external devices (not shown) such as the storage devices and display device, with one or more devices enabling the user to interact with the computing device 2300, or any devices (such as a network card, a modem and the like) enabling the computing device 2300 to communicate with one or more other computing devices, if required. Such communication can be performed via input/output (I/O) interfaces (not shown).

In some embodiments, instead of being integrated in a single device, some or all components of the computing device 2300 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2300 may be used to implement visual data encoding/decoding in embodiments of the present disclosure. The memory 2320 may include one or more visual data coding modules 2325 having one or more program instructions. These modules are accessible and executable by the processing unit 2310 to perform the functionalities of the various embodiments described herein.

In the example embodiments of performing visual data encoding, the input device 2350 may receive visual data as an input 2370 to be encoded. The visual data may be processed, for example, by the visual data coding module 2325, to generate an encoded bitstream. The encoded bitstream may be provided via the output device 2360 as an output 2380.

In the example embodiments of performing visual data decoding, the input device 2350 may receive an encoded bitstream as the input 2370. The encoded bitstream may be processed, for example, by the visual data coding module 2325, to generate decoded visual data. The decoded visual data may be provided via the output device 2360 as the output 2380.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
performing, with a neural network (NN)-based model, a conversion between visual data and a bitstream of the visual data based on a plurality of decoding profiles for decoding the bitstream, the plurality of decoding profiles being different from each other.

2. The method of claim 1, wherein if a first decoding profile in the plurality of decoding profiles is used to decode the bitstream, a first reconstruction of the visual data is obtained by applying a first inverse transformation process to a reconstructed latent representation of the visual data, and
if a second decoding profile in the plurality of decoding profiles is used to decode the bitstream, a second reconstruction of the visual data is obtained by applying a second inverse transformation process to the reconstructed latent representation, the second decoding profile being different from the first decoding profile.

3. The method of claim 2, wherein the second inverse transformation process is different from the first inverse transformation process.

4. The method of claim 2, wherein if the first decoding profile is used to decode the bitstream, a first filtering process is applied to the first reconstruction, and
if the second decoding profile is used to decode the bitstream, a second filtering process is applied to the second reconstruction.

5. The method of claim 4, wherein the first filtering process is the same as the second filtering process.

6. The method of claim 5, wherein the first filtering process comprises an enhancement filtering process, and the second filtering process comprises an inter channel correlation information (ICCI) filtering process.

7. The method of claim 2, wherein the first inverse transformation process comprises a first inverse transformation sub-process for a first component of the visual data and a second inverse transformation sub-process for a second component of the visual data, the second component being different from the first component, and
the second inverse transformation process comprises a third inverse transformation sub-process for the first component and a fourth inverse transformation sub-process for the second component.

8. The method of claim 7, wherein the first component is a chroma component and the second component is a luma component, or
the first component is a luma component and the second component is a chroma component.

9. The method of claim 7, wherein the first component is a primary component and the second component is a secondary component, or
the first component is a secondary component and the second component is a primary component.

10. The method of claim 7, wherein the first inverse transformation sub-process is different from the second inverse transformation sub-process, and the third inverse transformation sub-process is different from the fourth inverse transformation sub-process, and/or
wherein the first inverse transformation sub-process is different from the third inverse transformation sub-process, and the second inverse transformation sub-process is different from the fourth inverse transformation sub-process.

11. The method of claim 2, wherein the reconstructed latent representation of the visual data is obtained by applying a residual decoding process and a prediction process to the bitstream.

12. The method of claim 11, wherein the reconstructed latent representation of the visual data is obtained by applying a multi-stage context model (MCM) in the prediction process.

13. The method of claim 2, wherein an inverse transformation comprises a synthesis transform, or wherein an inverse transformation comprises at least one of the following: a convolution layer, a transposed convolution layer, or an activation layer.

14. The method of claim 2, wherein each of the first reconstruction and the second reconstruction is decoded visual data, or
wherein a size of the first reconstruction is the same as the second reconstruction, or
wherein each of the first reconstruction and the second reconstruction comprises 3 components, and each of the first reconstruction and the second reconstruction is in a red-green-blue (RGB) color format or a YUV color format, or
wherein samples of each of the first reconstruction and the second reconstruction are visual representations to be displayed.

15. The method of claim 1, wherein each of the plurality of decoding profiles is supported by the bitstream, or
wherein the visual data comprise a video, a picture of the video, or an image.

16. The method of claim 1, wherein the conversion includes encoding the visual data into the bitstream.

17. The method of claim 1, wherein the conversion includes decoding the visual data from the bitstream.

18. An apparatus for visual data processing comprising a processor and a non-transitory memory with instructions thereon, wherein the instructions upon execution by the processor, cause the processor to perform operations comprising:
performing, with a neural network (NN)-based model, a conversion between visual data and a bitstream of the visual data based on a plurality of decoding profiles for decoding the bitstream, the plurality of decoding profiles being different from each other.

19. A non-transitory computer-readable storage medium storing instructions that cause a processor to perform operations comprising:
performing, with a neural network (NN)-based model, a conversion between visual data and a bitstream of the visual data based on a plurality of decoding profiles for decoding the bitstream, the plurality of decoding profiles being different from each other.

20. A non-transitory computer-readable recording medium storing a bitstream of visual data which is generated by a method performed by an apparatus for visual data processing, wherein the method comprises:
performing, with a neural network (NN)-based model, a conversion between the visual data and the bitstream based on a plurality of decoding profiles for decoding the bitstream, the plurality of decoding profiles being different from each other.
